(19) United States
(12) Patent Application Publication
(10) Pub. No.: US 2025/0307187 A1
(43) Pub. Date: Oct. 2, 2025

(54) NETWORK CONTROLLER AND NETWORK CONTROL METHOD

(71) Applicant: SigmaStar Technology Ltd., Xiamen (CN)

(72) Inventors: Qin Wei SHE, Xiamen (CN); Yan Xiong WU, Xiamen (CN); Shi Xiang ZHENG, Xiamen (CN)

(21) Appl. No.: 19/034,733

(22) Filed: Jan. 23, 2025

(30) Foreign Application Priority Data
Mar. 29, 2024 (CN) 202410382062.7

(51) Int. Cl. G06F 13/24; G06F 13/28; H04L 49/90

(52) U.S. Cl. CPC G06F 13/24; G06F 13/28; H04L 49/90; G06F 2213/2406

(57) ABSTRACT

A network controller includes a data check circuit and an interrupt controller circuit. The data check circuit verifies whether multiple packets are valid. The interrupt controller circuit counts according to a first packet in the multiple packets when the first packet is valid to generate a first count value, and issues an interrupt signal to a processor when the first count is equal to a first predetermined value.

This application claims the benefit of China application Serial No. CN202410382062.7, filed on Mar. 29, 2024, the subject matter of which is incorporated herein by reference.

### BACKGROUND OF THE INVENTION

### Field of the Invention

The present application relates to a network controller, and more particularly to a network controller and a network control method capable of delaying a processor interrupt mechanism.

### Description of the Related Art

In a current network controller, after a transmitter successfully sends a packet, the network controller notifies a main processor to continue executing a task queue of writing packets to be sent. If the current network speed is not fast enough, an available storage space of a buffer temporarily storing the packets to be sent will be fully occupied. Under the condition above, the network controller notifies the main processor to stop writing packets to the buffer. In this case, the main processor repeatedly performs the operation above in response to the multiple notifications from the network controller, such that a load of the main processor is significantly increased to lead to degradation of the overall system performance.

### SUMMARY OF THE INVENTION

In some embodiments, it is an object of the present application to provide a network controller capable of delaying a processor interrupt mechanism and a network control method thereof so as to improve the issues of the prior art.

In some embodiments, a network controller includes a data check circuit and an interrupt controller circuit. The data check circuit verifies whether multiple packets are valid. The interrupt controller circuit counts according to a first packet in the plurality of packets when the first packet is valid to generate a first count value, and issues an interrupt signal to a processor when the first count is equal to a first predetermined value.

In some embodiments, a network control method includes operations of: verifying whether a plurality of packets are valid; and counting according to a first packet in the plurality of packets when the first packet is valid to generate a first count value, and sending an interrupt signal to a processor when the first count is equal to a first predetermined value.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a network system according to some embodiments of the present application.

FIG. 2A is a schematic diagram of the interrupt controller circuit in FIG. 1 according to some embodiments of the present application.

FIG. 2B is a schematic diagram of another interrupt controller circuit in FIG. 1 according to some embodiments of the present application.

FIG. 3 is a flowchart of operations of the detection circuit in FIG. 1 according to some embodiments of the present application.

FIG. 4 is a flowchart of operations of the interrupt controller circuit in FIG. 1 in a first mode according to some embodiments of the present application.

FIG. 5 is a flowchart of operations of the interrupt controller circuit in FIG. 1 in a second mode according to some embodiments of the present application.

FIG. 6 is a flowchart of a network control method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

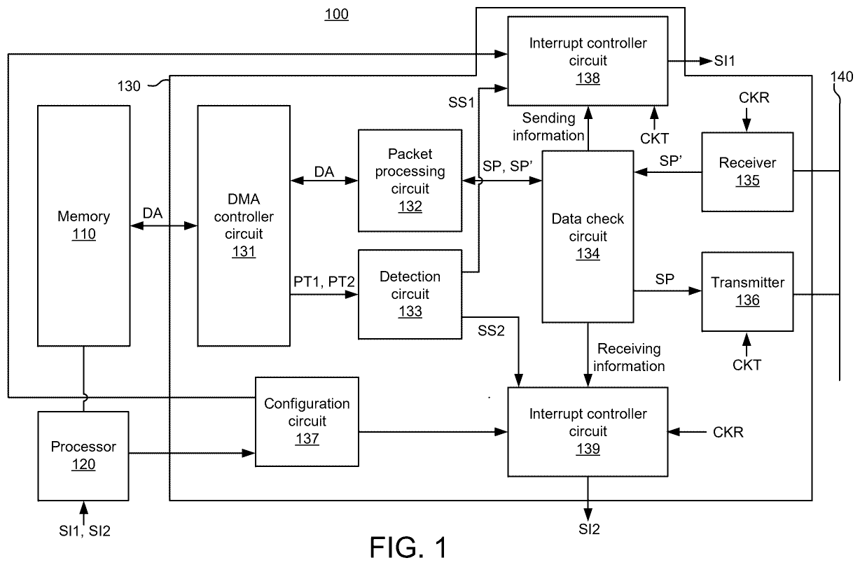

FIG. 1 shows a schematic diagram of a network system 100 according to some embodiments of the present application. The network system 100 includes a memory 110, a processor 120 and a network controller 130. In some embodiments, the network system 100 may be, for example but not limited to, a network system applied to the Ethernet. The memory 110 may store multiple sets of data DA to be processed, which may be data received by the network system 100 from another device (not shown) or data to be transmitted by the network system 100 to another device. In some embodiments, the memory 110 may be, for example but not limited to, a dynamic random access memory (DRAM). The processor 120 and the network controller 130 may operate in collaboration, so as to receive data from another device or to transmit data to another device. For example, the processor 120 may receive an interrupt signal SI1 and an interrupt signal SI2 issued by the network controller 130, so as to perform data transmission (including writing data to the memory 110 and/or reading data from the memory 110) with the memory 110. In some embodiments, the network controller 130 is operable as a media access control (MAC) controller.

In some embodiments, the network controller 130 includes a direct memory access (DMA) controller circuit 131, a packet processing circuit 132, a detection circuit 133, a data check circuit 134, a receiver 135, a transmitter 136, a configuration circuit 137, an interrupt controller circuit 138 and an interrupt controller circuit 139. The DMA controller circuit 131 may sequentially read the multiple sets of data DA from the memory 110, and transfer the data DA to a buffer (not shown) in the DMA controller circuit 131. Alternatively, the DMA controller circuit 131 may sequentially transfer the data DA, obtained by splitting a packet SP′ received from another device, from a buffer (not shown) in the DMA controller circuit 131 to the memory 110.

In some embodiments, the packet processing circuit 132 may encapsulate the multiple sets of data DA into a packet SP, or split the receive packet SP into the multiple sets of data DA. For example, the packet processing circuit 132 may receive the data DA via the DMA controller circuit 131, and perform predetermined data processing (for example but not limited to, adding additional information based on a transmission protocol requirement) on the data DA to generate the packet SP. The data check circuit 134 may receive the packet SP via the packet processing circuit 132, and verify whether the packet SP is valid. For example, the data check circuit 134 may perform data size check, cyclic redundancy check (CRC) and MAC address check, and determine that the packet SP is valid if the packet SP successfully passes the multiple checks above. If the data check circuit 134 determines that the packet SP is an invalid packet, the data check circuit 134 may discard the packet SP. Similarly, the packet processing circuit 132 may perform corresponding data processing on the packet SP′ received by the receiver 135 based on the transmission protocol requirement, so as to split the packet SP′ into the data DA.

In a different embodiment, the data DA may be encapsulated by the packet processing circuit 132 into the packet SP to be sent by the transmitter 136, or may be obtained by means of splitting by the packet processing circuit 132 the packet SP′ received by the receiver 135. If the packet to be checked is the packet SP to be sent and the packet SP is valid, the data check circuit 134 sends the packet SP to the transmitter 136, such that the transmitter 136 may transmit the packet SP to another device via a bus 140. In some embodiments, the bus 140 may be, for example but not limited to, a media-independent interface. Similarly, if the packet to be checked is the packet SP′ received by the receiver 135, the data check circuit 134 may verify whether the packet SP′ is valid. If the packet SP′ is valid, the data check circuit 134 may transfer the packet SP′ to the packet processing circuit 132, and the packet processing circuit 132 may split the packet SP′ into one set or multiple sets of data DA and transmit the data DA to the DMA controller circuit 131, accordingly the data DA is stored from the DMA controller circuit 131 to the memory 110.

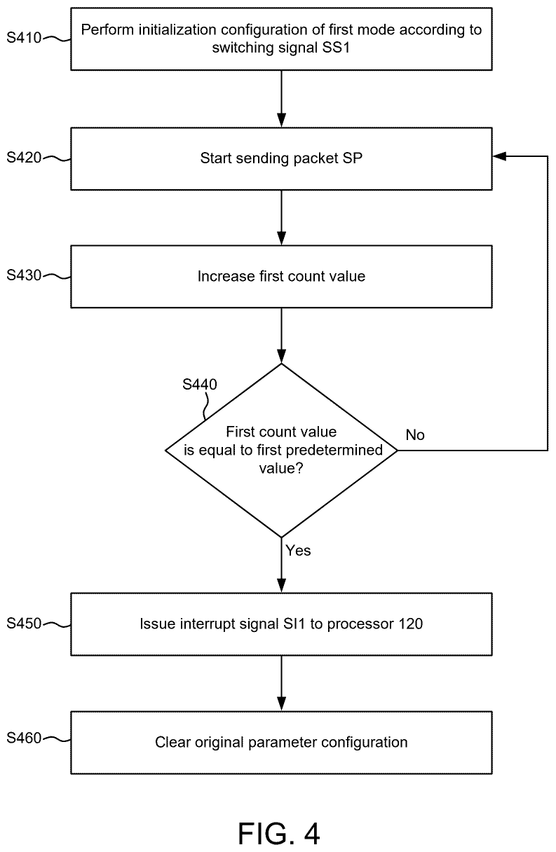

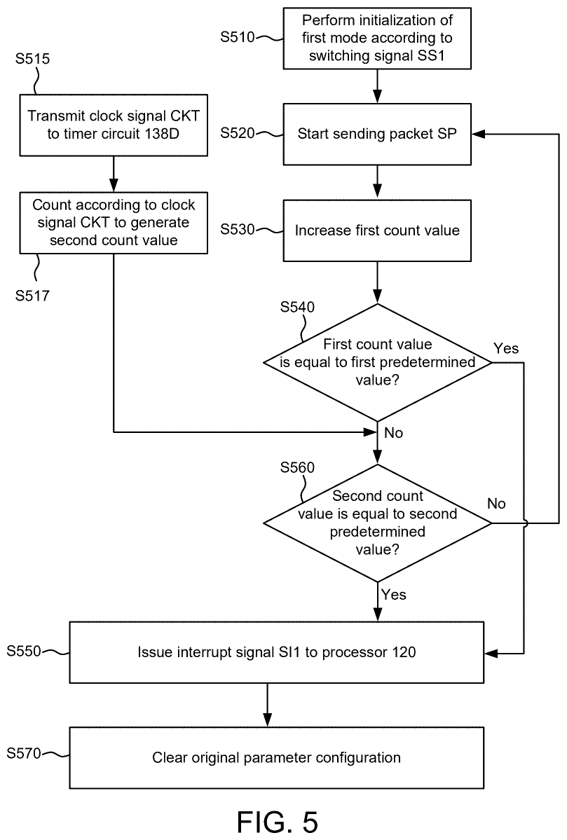

As described above, the DMA controller circuit 131 may transfer the data DA from the memory 110 to an internal buffer thereof. In some embodiments, while the data DA is being transferred, the DMA controller circuit 131 may generate a pointer signal PT1 to indicate an amount of data to be processed (equivalent to a total size of remaining data DA in the buffer) in the buffer. For example, the buffer may be a ring buffer, which may write data according to a write pointer and read data according to a read pointer, and the DMA controller circuit 131 may output a difference between the read pointer and the write pointer as the pointer signal PT1. The detection circuit 133 may determine a change rate of the amount of data to be processed in the buffer according to the pointer signal PT1, and determine whether the change rate of the amount of data to be processed exceeds a threshold to determine an operating condition of a current environment so as to generate the corresponding switching signal SS1. For example, if the change rate does not exceed the threshold, it means that the current speed at which the network system 100 sends the packet SP (or the speed at which the network controller 130 reads the data DA from the memory 110) is slightly lower than the speed at which the processor 120 writes the data DA to be sent to the memory 110. Under the condition above, the detection circuit 133 may generate the switching signal SS1 having a first level (or having a first value). According to the switching signal SS1 having the first level, the interrupt controller circuit 138 may operate in a first mode (with the operation thereof corresponding to FIG. 4) to generate a first count value to be described below. Alternatively, if the change rate exceeds the threshold, it means that the current speed at which the network system 100 sends the packet SP is far lower than the speed at which the processor 120 writes the data DA to be sent to the memory 110. Under the condition above, the detection circuit 133 may generate the switching signal SS1 having a second level (or having a second value different from the first value). According to the switching signal SS1 having the second level, the interrupt controller circuit 138 may operate in a second mode (with the operation thereof corresponding to FIG. 5) to generate the first count value and a second count value to be described below.

The interrupt controller circuit 138 operates according to the switching signal SS1, and the interrupt controller circuit 139 operates according to the switching signal SS2. In some embodiments, the interrupt controller circuit 138 and the interrupt controller circuit 139 have the same operation logic. Taking the interrupt controller circuit 138 for example, in the first mode, when the data check circuit 134 verifies that a first packet in the multiple packets SP is valid, the data check circuit 134 transmits the first packet to the transmitter 136 and sending information of the first packet to the interrupt controller circuit 138. In some embodiments, the sending information of the first packet is for indicating that the first packet has been sent. The transmitter 136 may transmit the first packet to another device, and the interrupt controller circuit 138 may count according to the sending information of the first packet so as to increase the first count value by 1. Then, when the data check circuit 134 determines that a second packet in the multiple packets SP is valid, the data check circuit 134 sends the second packet to the transmitter 136 and sending information of the second packet to the interrupt controller circuit 138. The transmitter 136 may transmit the second packet to another device, and the interrupt controller circuit 138 may count according to the sending information of the second packet such that the value of the first count value is adjusted to 2. Accordingly, when the interrupt controller circuit 138 determines that the first count value is equal to the first predetermined value, the interrupt controller circuit 138 issues the interrupt signal SI1 to the processor 120. The processor 120 may continue writing the data DA to be sent to a task queue of the memory 110 according to the interrupt signal SI, thereby starting to store the data DA to be sent to the memory 110. Thus, the data DA may be used to generate the corresponding packet SP by the related operations of the above circuits including the DMA controller circuit 131, the packet processing circuit 132 and the data check circuit 134, and the packet SP may be sent to another device by the transmitter 136.

In the second mode, the interrupt controller circuit 138 may further count according to a clock signal CKT to generate the second count value, and issue the interrupt signal SI1 to the processor 120 when the second count value is equal to a second predetermined value. In other words, in the second mode, the interrupt controller circuit 138 generates the interrupt signal SI1 based on the first count value and the second count value. If the condition that the first count value is equal to the first predetermined value is established before the condition that the second count value is equal to the second predetermined value, the interrupt controller circuit 138 similarly issues the interrupt signal SI1 to the processor 120, and vice versa. In some embodiments, the clock signal CKT may be a clock signal used by the transmitter 136; for example, the transmitter 136 may send the packet SP according to the clock signal CKT. In other words, in some embodiments, the interrupt controller circuit 138 and the transmitter 136 may share the clock signal CKT so as to reduce circuit design costs.

On the other hand, the DMA controller circuit 131 (or the packet processing circuit 132) may further temporarily store the data DA (corresponding to the packet SP′ received by the receiver 135) to an internal buffer (not shown). When the data check circuit 134 verifies that the packet SP′ received by the receiver 135 is valid, the DMA controller circuit 131 (or the packet processing circuit 132) may temporarily store the data DA corresponding to the packet SP′ to the buffer, thereby transferring the data DA to the memory 110. Thus, the processor 120 may read the data DA corresponding to the packet SP′ from the memory 110.

In some embodiments, while the data DA corresponding to the packet SP′ is being transferred from the buffer to the memory 110, the DMA controller circuit 131 may generate a pointer signal PT2 to indicate the amount of data to be processed (equivalent to the total size of remaining data DA in the buffer) in the buffer. Similarly, the DMA controller circuit 131 may output a difference between the read pointer and the write pointer corresponding to the buffer as the pointer signal PT2, and the detection circuit 133 may determine the change rate of the amount of data to be processed in the buffer according to the pointer signal PT2, and determine whether the change rate of the amount of data to be processed exceeds a second threshold to determine the operating condition of the current environment so as to generate the corresponding switching signal SS2. For example, if the change rate does not exceed the second threshold, it means that the current speed at which the network system 100 receives the packet SP′ (or the speed at which the network system 130 writes the data DA corresponding to the packet SP′ to the memory 110) is slightly lower than the speed at which the processor 120 reads the data DA corresponding to the packet SP′ from the memory 110. Under the condition above, the detection circuit 133 may generate the switching signal SS2 having a first level. According to the switching signal SS2 having the first level, the interrupt controller circuit 139 may operate in a first mode to generate a third count value (corresponding to the first count value generated by the interrupt controller circuit 138). Alternatively, if the change rate exceeds the second threshold, it means that the current speed at which the network system 100 receives the packet SP′ is far lower than the speed at which the processor 120 reads the data DA corresponding to the packet SP′ from the memory 110. Under the condition above, the detection circuit 133 may generate the switching signal SS2 having a second level. According to the switching signal SS2 having the second level, the interrupt controller circuit 139 may operate in a second mode to generate a third count value and a fourth count value (corresponding to the second count value generated by the interrupt controller circuit 139) to be described below.

In the first mode, when the data check circuit 134 verifies that the first packet received by the receiver 135 is valid, the data check circuit 134 sends receiving information of the first packet to the interrupt controller circuit 139, and sends the data DA corresponding to the first packet to the DMA controller circuit 131 via the packet processing circuit 132. In some embodiments, the receiving information of the first packet is for indicating that the first packet has been received. The interrupt controller circuit 139 may count according to the receiving information of the first packet to increase the third count value by 1. Then, when the data check circuit 134 verifies that the second packet received by the receiver 135 is valid, the data check circuit 134 sends receiving information of the second packet to the interrupt controller circuit 139, and sends the data DA corresponding to the second packet to the DMA controller circuit 131 via the packet processing circuit 132. The interrupt controller circuit 139 may count according to the receiving information of the second packet to adjust the third count value to 2. Accordingly, when the interrupt controller circuit 139 determines that the third count value is equal to a third predetermined value, the interrupt controller circuit 139 issues the interrupt signal SI2 to the processor 120. The processor 120 may continue executing the task queue of reading the data DA corresponding to the packet from the memory 110, thereby starting to read the data DA from the memory 110.

In the second mode, the interrupt controller circuit 139 further counts according to a clock signal CKR to generate a fourth count value, and issues the interrupt signal SI2 to the processor 120 when the fourth count value is equal to a fourth predetermined value. In other words, in the second mode, the interrupt controller circuit 139 generates the interrupt signal SI2 based on the third count value and the fourth count value. If the condition that the third count value is equal to the third predetermined value is established before the condition that the fourth count value is equal to the fourth predetermined value, the interrupt controller circuit 139 similarly issues the interrupt signal SI2 to the processor 120, and vice versa. In some embodiments, the clock signal CKR is a clock signal used by the receiver 135; for example, the receiver 135 may receive a packet according to the clock signal CKR. In other words, in some embodiments, the interrupt controller circuit 139 and the receiver 135 may share the clock signal CKR so as to reduce circuit design costs.

In some related art, a network controller issues one interrupt signal to a processor while each packet is completely sent, so as to wake up the processor to continue executing a task queue of transmitting or receiving data (including tasks such as reading corresponding data from a memory and writing corresponding data to a memory). In the related art above, if the speed at which the network system sends packets is lower than the speed at which the processor writes data corresponding to a packet, the task queue will be full (equivalent to full occupancy of a storage space of a buffer in a DMA controller circuit). Under the condition above, the network controller issues an interrupt signal to notify the main processor to stop writing packets to the buffer. If the speed at which the network system sends packets is lower for an extended period of time than the speed at which the processor writes packets, the task queue is frequently in a full state, and the network controller then frequently issues interrupt signals (including an interrupt signal notifying the processor to stop writing packets and an interrupt signal for notifying the processor to continue executing the task queue of sending packets) to the processor, eventually leading to a significant increase in the load of the processor and hence degrading the overall system performance.

Different from the related art above, in some embodiments of the present invention, the interrupt controller circuit 138 may delay the issue of the interrupt signal SI1 by means of counting (instead of generating one interrupt signal SI1 each time while a packet is sent), thereby reducing the number of times of issuing the interrupt signal SI1. On the other hand, if the speed at which packets are sent is too low or the duration of a slowed down speed persists for overly long, the first count value may not be equal to the first predetermined value for an extended period of time. Under the condition above, the interrupt controller circuit 138 may forcibly wake up the processor 120 by using a second value to execute the task queue of sending packets, thereby preventing missed packets. Similarly, compared to the related art above, in the operation of receiving packets, the interrupt controller 139 may also achieve the same improvement on the basis of operations same as the above.

The configuration circuit 137 may set multiple parameters according to the control of the processor 120, and update registers (not shown) in the interrupt controller circuit 138 and the interrupt controller circuit 139 with these parameters, so that the interrupt controller circuit 138 and the interrupt controller circuit 139 may perform the related operations above according to these parameters. In some embodiments, the parameters above may include the first predetermined value, the second predetermined value, the third predetermined value and the fourth predetermined value. In some embodiments, the processor 120 may adjust the parameters above according to user requirements or current environmental conditions. For example, if the speed at which the network system 100 sends packets increases, the processor 120 may increase the first predetermined value. Similarly, if the speed at which the network system 100 receives packets increases, the processor 120 may increase the third predetermined value.

In some embodiments, each circuit in the network controller 130 may be implemented by at least one digital circuit. For example, each of the circuits may be implemented by a state machine or at least one digital logic circuit, microcontroller circuit or application-specific integrated circuit executing a corresponding operation; however, the present application is not limited to the examples above.

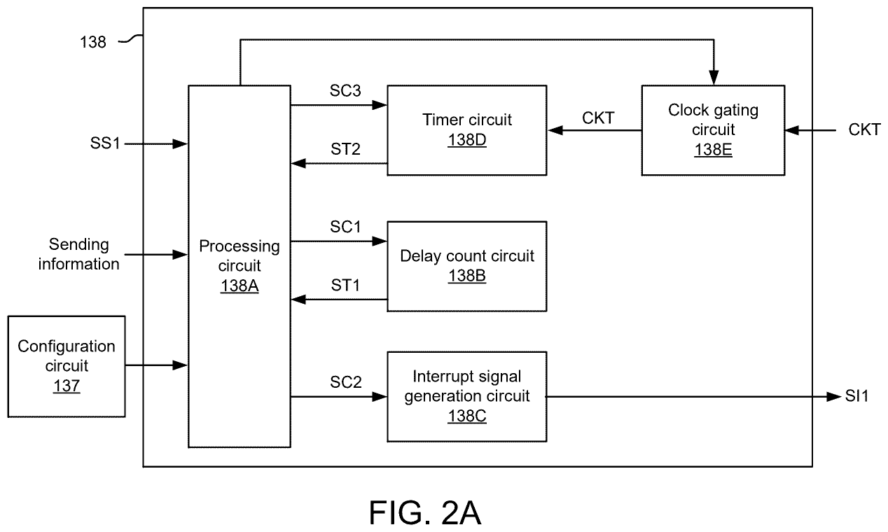

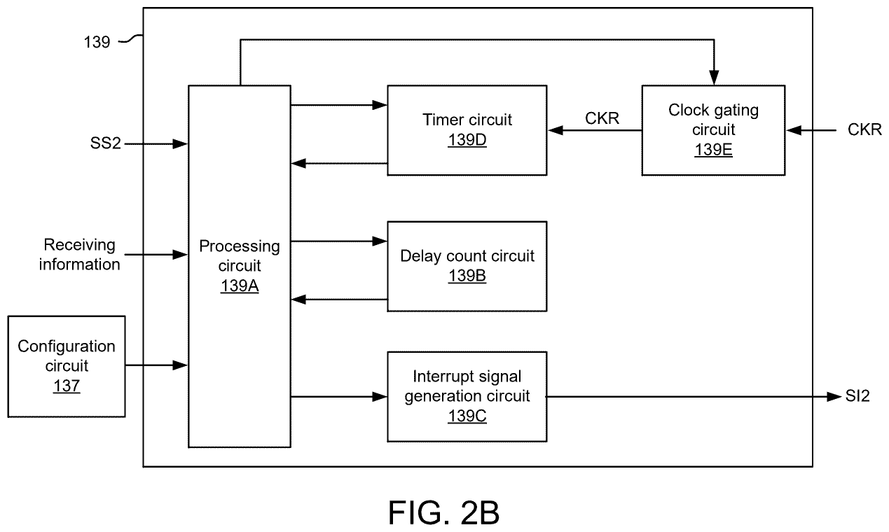

FIG. 2A shows a schematic diagram of the interrupt controller circuit 138 in FIG. 1 according to some embodiments of the present application. The interrupt controller circuit 138 includes a processing circuit 138A, a delay count circuit 138B, an interrupt signal generation circuit 138C, a timer circuit 138D and a clock gating circuit 138E. The processing circuit 138A may receive multiple parameters from the configuration circuit 137, and store the multiple parameters in an internal register (not shown) thereof. The processing circuit 138A may generate a control signal SC1 according to the switching signal SS1 and the sending/receiving information of the multiple packets SP (for example, sending information with respect to the interrupt controller circuit 138, and receiving information with respect to the interrupt controller circuit 139), and generate a control signal SC2 according to a trigger signal ST1 generated by the delay count circuit 138B. The delay count circuit 138B may generate the first count value above according to the control signal SC1, and generate the trigger signal ST1 according to the first count value and the first predetermined value. For example, the processing circuit 138A may operate in a first mode according to the switching signal SS1. Under the condition above, if the processing circuit 138A receives sending information of packets, the processing circuit 138A outputs the control signal SC1 to cause the delay count circuit 138B to correspondingly generate the first count value. Similarly, as the amount of sending information of packets received by the processing circuit 138A increases, the first count value also increased gradually. When the first count value is equal to the first predetermined value, the delay count circuit 138B outputs the trigger signal ST1, such that the processing circuit 138A accordingly generates the control signal SC2. As such, the interrupt signal generation circuit 138C may generate the interrupt signal SI1 according to the control signal SC2.

In some further embodiments, the processing circuit 138A further generates a control signal SC3 according to the sending information of the packet SP and the switching signal SS1, and generates the control signal SC2 according to one of the trigger signal ST1 and the trigger signal ST2. For example, the processing circuit 138A may operate in the second mode according to the switching signal SS1, and send the control signal SC3 to the timer circuit 138D to cause the timer circuit 138D to complete initialization configuration. Under the condition above, if the processing circuit 138A receives the sending information of the packet SP, the processing circuit 138A outputs the control signal SC1 to cause the delay count circuit 138B to correspondingly generate the first count value, and enables the clock gating circuit 138E so as to transmit the clock signal CKT to the timer circuit 138D. Thus, the timer circuit 138D may generate the second count value according to the clock signal CKT. As the amount of sending information of the valid packet SP received by the processing circuit 138A increases, the first count value also increased gradually, and at the same time the second count value also increases along with the time. When the first count value is equal to the first predetermined value, the delay count circuit 138B outputs the trigger signal ST1. Similarly, when the second count value is equal to the second predetermined value, the timer circuit 138D outputs the trigger signal ST2. The processing circuit 138A may generate the control signal SC2 according to one (the one that transients earlier in time) of the trigger signal ST1 and the trigger signal ST2. As such, the interrupt signal generation circuit 138C may generate the interrupt signal SI1 according to the control signal SC2.

FIG. 2B shows a schematic diagram of the interrupt controller circuit 139 in FIG. 1 according to some embodiments of the present application. The interrupt controller circuit 139 includes a processing circuit 139A, a delay count circuit 139B, an interrupt signal generation circuit 139C, a timer circuit 139D and a clock gating circuit 139E. Different from FIG. 2A, in FIG. 2B, the processing circuit 139A receives the switching signal SS2, and the packet received by the processing circuit 139A is the packet SP′ received by the receiver 135. The operations of the remaining circuits in FIG. 2B are the same as or corresponding to the operations of the multiple circuits in FIG. 2A, and such repeated details are omitted herein.

As described above, in some embodiments, according to the interrupt signal SI1 issued by the interrupt controller circuit 138 or the interrupt signal SI2 issued by the interrupt controller circuit 139, the processor 120 may perform data transmission (including writing the data DA corresponding to the packet SP to the memory 110 or reading the data DA corresponding to the received packet SP′ from the memory 110) with the controller 110. To keep the description brief and to prevent undue repeated details, related operations of the interrupt controller circuit 138 that processes the packet SP to be transmitted are given as an example below. However, the related process is also applicable to the interrupt controller circuit 139 that processes the packet SP′ received by the receiver 135.

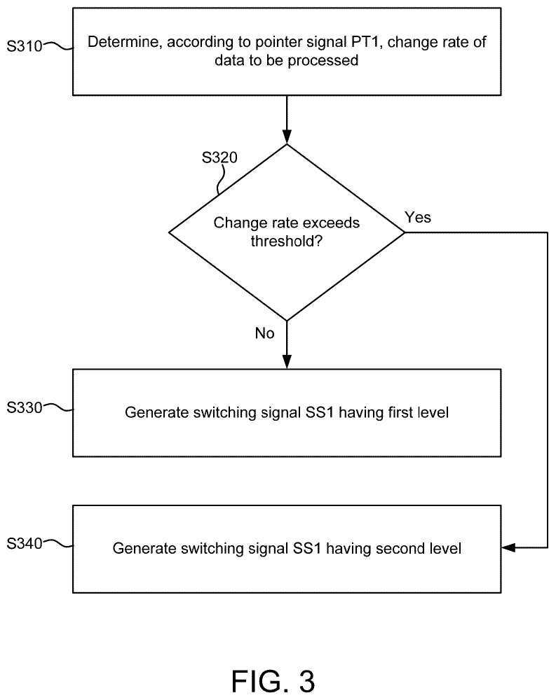

FIG. 3 shows a flowchart of operations of the detection circuit 133 in FIG. 1 according to some embodiments of the present application. In operation S310, a change rate of an amount of data to be processed is determined according to the pointer signal PT1. For example, the detection circuit 133 may record the change of the amount of data to be processed in a buffer storing the packet SP in the DMA controller circuit 131 within a predetermined period of time to thereby determine the change rate of the amount of data to be processed. In operation S320, it is determined whether the change rate exceeds a threshold. If the change rate does not exceed the threshold, operation S330 is performed. If the change rate exceeds the threshold, operation S340 is performed. In operation S330, the switching signal SS1 having the first level is generated to cause the interrupt controller circuit 138 to operate in the first mode. In operation S340, the switching signal SS2 having the second level is generated to cause the interrupt controller signal 138 to operate in the second mode.

As described above, if the change rate does not exceed the threshold, it means that the current speed at which the network system 100 sends the packet SP is slightly lower than the speed at which the processor 120 writes the data DA corresponding to the packet SP to the memory 110. Under the condition above, the interrupt controller circuit 138 may operate in the first mode to determine by using the first count value whether to issue the interrupt signal SI1. Alternatively, if the change rate exceeds the threshold, it means that the speed at which the network system 100 currently sends the packet SP is far lower than the speed at which the processor 120 writes the data DA corresponding to the packet SP to the memory 110 (or the speed at which the network system 100 currently sends the packet SP is frequently lower than the speed at which the processor 120 writes the data DA corresponding to the packet SP to the memory 110). Under the condition above, the interrupt controller circuit 138 may operate in the second mode to determine by using both of the first and second count values whether to issue the interrupt signal SI1.

FIG. 4 shows a flowchart of operations of the interrupt controller circuit 138 in FIG. 1 in the first mode according to some embodiments of the present application. In operation S410, initialization configuration of the first mode is performed according to the switching signal SS1. For example, when the processing circuit 138A receives the switching signal SS1 having the first level, the processing circuit 138A may perform the initialization configuration according to multiple parameters received from the configuration circuit 137. The processing circuit 138A may configure multiple parameters in an internal register thereof to enable the delay count circuit 138B, set the first predetermined value to a first value, and clear the first count value to 0. In operation S420, sending of the packet SP begins. In operation S430, the first count value is increased. In operation S440, it is determined whether the first count value is equal to the first predetermined value. If so, operation S450 is performed. If not, operation S420 is performed again. In operation S450, the interrupt signal SI1 is issued to the processor 120. In operation S460, the original parameter configuration is cleared. For example, after the interrupt signal SI1 is issued to the processor 120, the processing circuit 138A may reset the multiple parameters in the register to disable the delay count circuit 138B.

FIG. 5 shows a flowchart of operations of the interrupt controller circuit 138 in FIG. 1 in the second mode according to some embodiments of the present application. In operation S510, initialization configuration of the second mode is performed according to the switching signal SS2. For example, when the processing circuit 138A receives the switching signal SS1 having the second level, the processing circuit 138A may perform the initialization configuration according to multiple parameters received from the configuration circuit 137. The processing circuit 138A may configure multiple parameters in an internal register thereof to enable the delay count circuit 138B and the timer circuit 139D, set the first and second predetermined values to first and second values respectively, and clear the first and second count values to 0. In operation S520, sending of the packet SP begins. In operation S530, the first count value is increased. In operation S540, it is determined whether the first count value is equal to the first predetermined value. If so, operation S550 is performed. If not, operation S560 is performed. In operation S550, the interrupt signal SI1 is issued to the processor 120.

In operation S515, the clock signal CKT is transmitted to the timer circuit 138D. Executing of operation S515 begins based on the sending information of the first packet. In operation S517, counting may be performed according to the clock signal CKT to generate the second count value. In some embodiments, the timer circuit 138D may count according to a pulse wave of the clock signal CKT to gradually increase the second count value. For example, if the frequency of the clock signal CKT is 125 MHZ, the cycle corresponding to one pulse of the clock signal CTK is approximately 8 ns. If the duration corresponding to the second predetermined value is 8 ms, the timer circuit 138D may increase the second count value to be equal to the second predetermined value upon counting to the 1000000th pulse. It should be noted that the related numerical values above are merely examples, and the present application is not limited to such examples.

In operation S560, it is determined whether the second count value is equal to the second predetermined value. If the second count value is equal to the second predetermined value, operation S550 is performed. Otherwise, if the second count value is different from the second predetermined value, operation S520 is performed once again, and the process continues to operation S515 and operation S517 at this point. In operation S570, the original parameter configuration is cleared. For example, after the interrupt signal SI1 is issued to the processor 120, the processing circuit 138A may reset the multiple parameters in the register to disable the delay count circuit 138B and the timer circuit 138D, and may reset the first count value and the second count value to 0. In some embodiments, if a timing at which the first count value is equal to the first predetermined value is earlier than a timing at which the second count value is equal to the second predetermined value, the processing circuit 138A may first reset the second count value. Alternatively, if a timing at which the second count value is equal to the second predetermined value is earlier than a timing at which the first count value is equal to the first predetermined value, the processing circuit 138A may first reset the first count value.

In some embodiments, the process in FIG. 4 or FIG. 5 may be activated when the data capacity of the buffer in the DMA controller 131 is full (or nearly full); however, the present application is not limited to the example above. In some embodiments, the interrupt controller circuit 138 in FIG. 2A may exclude the timer circuit 138D, and the interrupt controller circuit 139 in FIG. 2B may exclude the timer circuit 139D. Under the condition above, the network controller 130 may directly configure the interrupt controller circuit 138 and the interrupt controller circuit 139 to the first mode under the premise that the detection circuit 133 is not used. In other words, in different embodiments, the implementation of the network controller 130 is not limited to the configurations presented in the various drawings above.

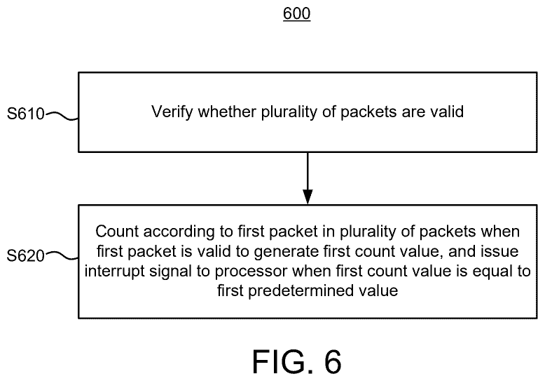

FIG. 6 shows a flowchart of a network control method 600 according to some embodiments of the present application. In some embodiments, the network control method 600 may be performed by a network controller chip, or be performed by collaborated operations between software and/or firmware and hardware. In operation S610, it is verified whether multiple packets are valid. In operation S620, counting is performed according to a first packet in the plurality of packets when the first packet is valid to generate a first count value, and an interrupt signal is issued to a processor when the first count is equal to a first predetermined value. Thus, when a processor receives the interrupt signal, the processor may perform, according to the interrupt signal, data transmission with a memory (for example, the memory 110 in FIG. 1) storing the plurality of packets.

The multiple operations in FIG. 4, FIG. 5 and/or FIG. 6 are merely examples, and are not limited to being performed in the order specified in the examples. Without departing from the operation means and ranges of the various embodiments of the present application, additions, replacements, substitutions or omissions may be made to the operations in FIG. 4, FIG. 5 and/or FIG. 6, or the operations may be performed in different orders (for example, entirely simultaneously performed or partially simultaneously performed).

In conclusion, by using multiple counting means, the network controller and the network control method provided according to some embodiments of the present application are capable of reducing the number of times of issuing an interrupt signal, thereby effectively reducing a load of a processor in different network environments and hence maintaining system performance.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A network controller, comprising:
a data check circuit, verifying whether a plurality of packets are valid; and
an interrupt controller circuit, counting according to a first packet in the plurality of packets to generate a first count value when the first packet is valid, and issuing an interrupt signal to a processor when the first count value is equal to a first predetermined value.

2. The network controller according to claim 1, wherein the interrupt controller circuit further counts according to a clock signal to generate a second count value, and issues the interrupt signal to the processor when the second count value is equal to a second predetermined value.

3. The network controller according to claim 2, wherein if the plurality of packets are packets to be sent by a transmitter, the clock signal is a clock signal used by the transmitter, and if the plurality of packets are packets to be received by a receiver, the clock signal is a clock signal used by the receiver.

4. The network controller according to claim 1, further comprising:
a direct memory access (DMA) controller circuit, comprising a buffer, the DMA controller circuit transfers data corresponding to the plurality of packets to the buffer and generating an indicator signal to indicate an amount of data to be processed in the buffer; and
a detection circuit, determining according to the indicator signal whether a change rate of the amount of data to be processed exceeds a threshold to generate a switching signal;
wherein the interrupt controller circuit operates in a first mode or a second mode according to the switching signal.

5. The network controller according to claim 4, wherein when the change rate does not exceed the threshold, the interrupt controller circuit operates in the first mode according to the switching signal to generate the first count value; and when the change rate exceeds the threshold, the interrupt controller circuit operates in the second mode according to the switching signal to generate the first count value and the second count value.

6. The network controller according to claim 1, wherein the interrupt controller circuit comprises:
a processing circuit, generating a first control signal according to sending/receiving information of the plurality of packets and a switching signal having a first level, wherein the switching signal is generated by a detection circuit according to a relation between a change rate of an amount of data to be processed in a buffer and a threshold;
a delay count circuit, generating the first count value according to the first control signal, and generating a first trigger signal according to the first count value and the first predetermined value, wherein the processor circuit further generates a second control signal according to the first trigger signal; and
an interrupt signal generation circuit, generating the interrupt signal according to the second control signal.

7. The network controller according to claim 6, wherein the interrupt controller circuit further comprises:
a timer circuit, generating a second count value according to a third control signal and a clock signal, and generating a second trigger signal according to the second count value and a second predetermined value;
wherein, the processing circuit further generates the third control signal according to sending/receiving information of the plurality of packets and the switching signal having a second level, and generates the second control signal according to one of the first trigger signal and the second trigger signal.

8. A network control method, comprising:
verifying whether a plurality of packets are valid;
counting according to a first packet in the plurality of packets to generate a first count value when the first packet is valid; and
issuing an interrupt signal to a processor when the first count value is equal to a first predetermined value.

9. The network control method according to claim 8, further comprising:
counting according to a clock signal to generate a second count value, and issuing the interrupt signal to the processor when the second count value is equal to a second predetermined value.

10. The network control method according to claim 9, further comprising:
transferring data corresponding to the plurality of packets from a memory via a direct memory access (DMA) controller circuit to a buffer of the DMA controller circuit, and generating an indicator signal to indicate an amount of data to be processed in the buffer;
determining according to the indicator signal whether a change rate of the amount of data to be processed exceeds a threshold to generate a switching signal; and
operating an interrupt controller circuit in a first mode or a second mode according to the switching signal, wherein the first count value is generated by the interrupt controller circuit.

11. The network control method according to claim 10, wherein the operating of the interrupt controller circuit in the first mode or the second mode according to the switching signal comprises:
when the change rate does not exceed the threshold, operating the interrupt controller circuit in the first mode according to the switching signal to generate the first count value; and
when the change rate exceeds the threshold, operating the interrupt controller circuit in the second mode according to the switching signal to generate the first count value and the second count value.
